(19) United States
(12) Patent Application Publication
(10) Pub. No.: US 2025/0355421 A1
(43) Pub. Date: Nov. 20, 2025

(54) METHOD AND DEVICE FOR AUTOMATICALLY DETERMINING THE VALUE OF A STATE VARIABLE OF A DRIVE TRAIN FOR MOVING A LOAD

(71) Applicant: TRUMPF Werkzeugmaschinen SE + Co. KG, Ditzingen (DE)

(72) Inventors: Wiebke Salome ZENN, Winterbach (DE); Alexander KECK, Ludwigsburg (DE); Eckhard BINDER, Steinheim (DE); Sebastian ROEDING, Rottendorf (DE); Marcus BECK, Igersheim (DE)

(21) Appl. No.: 19/286,314

(22) Filed: Jul. 31, 2025

Related U.S. Application Data
(63) Continuation of application No. PCT/EP2024/052399, filed on Jan. 31, 2024.

(30) Foreign Application Priority Data
Feb. 1, 2023 (DE) 102023200801.7

(51) Int. Cl. G05B 19/416; F16H 19/04; G01M 13/025

(52) U.S. Cl. CPC G05B 19/416; G01M 13/025; F16H 19/04

(57) ABSTRACT

A method is for automatically determining the value of a state variable of a drive train for moving a load. The drive train includes a drive and a drive element which is driven by the drive and moved with the load, and a fixed support element on which the drive element is supported, in order to move the load relative to the support element. The method includes the steps of accelerating the load by the drive by specifying a driving profile with acceleration reversal; during the acceleration of the load, detecting an ACTUAL acceleration of the drive and detecting an ACTUAL acceleration of the load; and determining the value of the state variable of the drive train by evaluating the detected ACTUAL accelerations of the drive and the load.

### CROSS REFERENCE TO RELATED APPLICATIONS

This application is a continuation of International Application No. PCT/EP2024/052399 (WO 2024160910 A1), filed on Jan. 31, 2024, and claims benefit to German Patent Application No. DE 10 2023 200 801.7, filed on Feb. 1, 2023. The aforementioned applications are hereby incorporated by reference herein.

### FIELD

The invention relates to a method and a device for automatically determining the value of a state variable of a drive train for moving a load.

### BACKGROUND

For example, well-known 2D laser cutting machines use a rack/pinion drive train for moving a translationally driven guide carriage. The drive train comprises a motor and a pinion driven by the motor via a gear, all of which are attached to the guide carriage and thus move together with the guide carriage, as well as a fixed rack with which the pinion meshes to move the guide carriage relative to the rack.

Due to manufacturing tolerances and to protect all components involved from wear, rack and pinion drives usually have some reverse play. Reverse play describes the distance between one tooth flank of the pinion and the next tooth flank of the rack when the opposite tooth flanks are in contact with each other.

The extent of this reverse play must be checked regularly to ensure the functionality of the machine. Since rack/pinion drives often do not have a direct measuring system installed, additional measuring technology must be installed for measuring the play and the value must be measured manually, e.g., during service calls. To date, a meter or a measuring probe has been mounted in such a way that the relative displacement of the guide carriage, to which the gear and pinion are attached, can be measured relative to the guide rail on which the guide carriage moves. The guide carriage is then moved manually along the guide rail and the distance traveled without the need for excessive force is read by the measuring probe or on the meter. This value corresponds to the reverse play.

### SUMMARY

In an embodiment, the present disclosure provides a method for automatically determining the value of a state variable of a drive train for moving a load. The drive train includes a drive and a drive element which is driven by the drive and moved with the load, and a fixed support element on which the drive element is supported, in order to move the load relative to the support element. The method includes the steps of accelerating the load by the drive by specifying a driving profile with acceleration reversal; during the acceleration of the load, detecting an ACTUAL acceleration of the drive and detecting an ACTUAL acceleration of the load; and determining the value of the state variable of the drive train by evaluating the detected ACTUAL accelerations of the drive and the load.

### BRIEF DESCRIPTION OF THE DRAWINGS

Subject matter of the present disclosure will be described in even greater detail below based on the exemplary figures. The embodiments shown and described should not be understood as an exhaustive list, but rather are of an exemplary character for describing the invention. All features described and/or illustrated herein can be used alone or combined in different combinations. The features and advantages of various embodiments will become apparent by reading the following detailed description with reference to the attached drawings, which illustrate the following:

FIG. 1 schematically shows a device according to an embodiment of the present invention for automatically determining a reverse play in a rack/pinion drive train;

FIG. 2a shows a reverse play in the pinion/rack drive train according to an embodiment of the present invention when accelerating the pinion on the rack counterclockwise;

FIG. 2b shows a reverse play in the pinion/rack drive train according to an embodiment of the present invention when accelerating the pinion on the rack clockwise;

FIG. 3 shows an exemplary driving profile (target trajectory) of a guide carriage shown in FIG. 1, moved by the drive train, when carrying out the method according to the invention for automatically determining the reverse play; and

FIG. 4 shows the time-synchronized ACTUAL accelerations of the drive and the load detected when carrying out the method according to an embodiment of the invention.

### DETAILED DESCRIPTION

Embodiments of the present invention are based on the object of disclosing a method and a device with which a state variable of the drive train, such as reverse play, can be measured automatically.

Embodiments according to the present invention include a method for automatically determining the value of a state variable of a drive train for moving a load, in particular embodiments a translationally driven load, wherein the drive train has a drive and a drive element which is driven by the drive and moved with the load, and a fixed support element on which the drive element is supported, in order to move the load relative to the support element, comprising the following method steps: accelerating the load by means of the drive by specifying a driving profile with acceleration reversal; during the acceleration of the load, detecting the ACTUAL acceleration of the drive and detecting the ACTUAL acceleration of the load; and determining a value of the state variable of the drive train by evaluating the detected ACTUAL accelerations of the drive and the load.

An embodiment of the present invention relates to a method and a device for automatically determining the value of a state variable of a drive train for moving a load, in particular embodiments a translationally driven load, wherein the drive train has a drive and a drive element which is driven by the drive and moved with the load, and a fixed support element on which the drive element is supported, in order to move the load relative to the support element.

According to embodiments of the present invention, the load is moved by means of a drive control according to the driving profile and accelerated in such a way that an acceleration reversal, i.e., a zero-crossing of the acceleration, takes place. During this movement, the drive-side acceleration (ACTUAL acceleration of the drive) and the output-side acceleration (ACTUAL acceleration of the load) are detected. By comparing these two detected acceleration signals, suitable algorithms can be used to determine the value of the state variable. During operation of the machine (whenever the load is switched from acceleration to braking), the state variable can be automatically monitored. The ACTUAL acceleration of the drive can, for example, correspond to the target acceleration of the load predetermined by the drive control. A method according to embodiments of the present invention can, as part of a state diagnosis, provide information about the state of the machine and, if necessary, provide support for fault diagnosis.

In preferred embodiments, the state variable is a reverse play of the drive train, which is inevitably present, for example, in a rack/pinion drive or a screw drive (e.g., a ball screw drive). The reverse play is particularly noticeable in the area when there is an acceleration reversal at the load. At this point, the tooth flanks of the pinion and rack separate from each other, and the load continues to travel until the reverse play has been completed once and the tooth flanks on the opposite side collide with each other. This allows the reverse play to be monitored automatically during machine operation. Alternatively, the state variable can also be, for example, an elasticity or a degree of contamination of the drive train.

In preferred embodiments, the co-moving drive element meshes with the fixed support element in order to move the load relative to the support element. For example, the moving drive element is a pinion and the fixed support element is a rack (or vice versa), both of which mesh with each other.

The drive is, in preferred embodiments, moved together with the load, but could alternatively not be used with the load, i.e., it could be fixed in the same way as the support element.

The ACTUAL acceleration of the drive is determined particularly advantageously from the detected speed of a drive designed as a rotary motor. The speed of the rotary motor can be detected, for example, by a motor measuring system that is usually already present in the rotary motor.

In preferred embodiments, the ACTUAL acceleration of the load is detected using an acceleration sensor attached to the load itself or to an element that moves with the load. The use of such an acceleration sensor is a very cost-effective solution, especially since so-called MEMS acceleration sensors are already available at low cost and in sufficiently good quality.

The ACTUAL accelerations of the drive and load are, in a preferred embodiment, detected synchronously during the acceleration of the load, but can alternatively be synchronized with each other retrospectively, i.e., after the detection processes.

In preferred embodiments, the predetermined driving profile comprises a forward and backward movement of the load. The load axis to be tested is moved forward and backward a few millimeters one or more times via the motor controller using a step-like (jerk-limited) trajectory in order to achieve an acceleration reversal through this reversal of movement. Alternatively, a driving profile with only forward movement of the load or only backward movement of the load is also possible, as long as there is an acceleration reversal.

The detected ACTUAL accelerations of the drive and load can be evaluated using various methods to determine the value of the state variable of the drive train.

In a first evaluation variable according to an embodiment, the relationship between the state variable and the changes in the acceleration processes of the ACTUAL accelerations of the drive and the load is experimentally ascertained and stored for different values of the state variable. When the tooth flanks collide after the acceleration reversal, the moving load mass is abruptly braked or the drive is jolted. The larger the state variable, the stronger these sudden changes in the acceleration processes are. This relationship can be experimentally ascertained and stored on the machine. Based on the stored relationship, the value of the state variable can be determined from the detected ACTUAL accelerations of the drive and the load.

In a second evaluation variant according to an embodiment, the relationship between the state variable and the period of time within which the drive and support elements separate from each other and come into contact with each other again during an acceleration reversal is experimentally ascertained and stored for different values of the state variable. The larger the state variable, the longer the period between the release and the re-collision of the tooth flanks. The moment of release is when the drive undergoes an acceleration reversal, e.g., when it switches from acceleration to braking. The moment of collision is when the mass acceleration decreases abruptly or the drive acceleration increases abruptly. The relationship between this period and the state variable can be experimentally ascertained and stored on the machine. Based on the stored relationship, the value of the state variable can be determined from the detected ACTUAL accelerations of the drive and the load.

In a third evaluation variable according to an embodiment, from the detected ACTUAL accelerations of the drive and the load, the points in time at which, during an acceleration reversal, the drive and support elements separate from each other and come into contact with each other again, the distance traveled and, from this, the value of the state variable are calculated analytically. If the acceleration measurement signals are of sufficiently good quality (resolution, noise), the distance traveled and thus the state variable can be calculated analytically from the time of tooth flank separation and the time of tooth flank collision.

Embodiments of the present invention also relate to a device for automatically determining the value of a state variable of a drive train for moving a load, in particular embodiments a translationally driven load, in particular for carrying out a method according to an embodiment of the present invention, comprising: a drive train having a drive and a drive element which is driven by the drive and moved with the load, and a fixed support element on which the drive element is supported, in order to move the load relative to the support element, a first device for detecting an ACTUAL acceleration of the drive, a second device for detecting the ACTUAL acceleration of the load, and an evaluation device which is programmed or configured to determine the value of a state variable of the drive train from the detected ACTUAL accelerations of the drive and the load.

In a preferred embodiment, the drive element meshes with the fixed support element and the drive also moves with the load.

The drive can be, for example, an electric rotary or linear motor or a hydraulic motor. In the case of an electric rotary motor, the first device is, in a preferred embodiment, formed by a motor measuring system already present in the rotary motor for determining the motor speed.

In advantageous embodiments, the drive train has a gear (e.g., planetary gear) acting between the drive and the drive element, which moves with the load.

The second device is, in a preferred embodiment, formed by an acceleration sensor, which is attached to the load itself or to an element that moves with the load.

In a preferred embodiment, the drive train is formed by a pinion/rack drive train, in particular with a pinion as the drive element and with a rack as the support element, or by a screw drive, in particular a ball screw drive.

Further advantages and advantageous embodiments of the subject matter of the invention are evident from the description, the claims and the drawing. Likewise, the features mentioned above and those yet to be presented may be used in each case alone or jointly in any desired combinations.

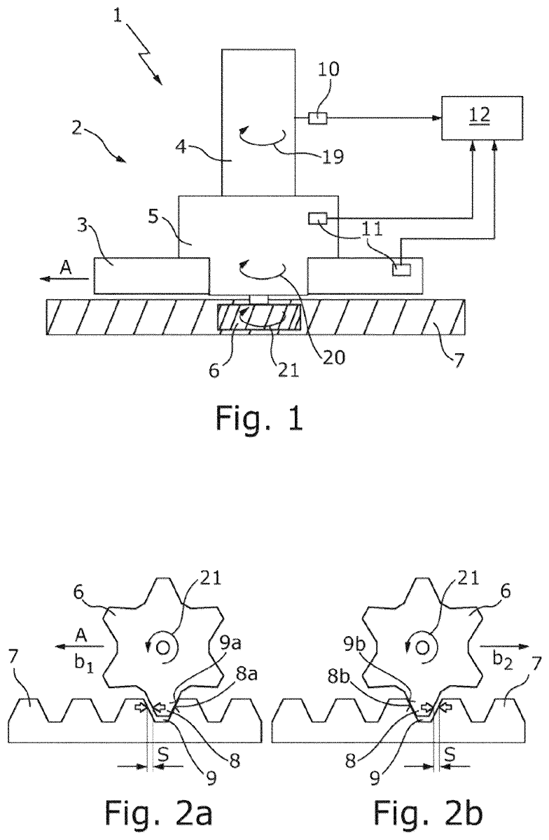

The device 1 shown in FIG. 1 is used for automatically determining the value of a state variable, in this case a reverse play S (FIGS. 2a, 2b), in a drive train 2 for moving a load, which is formed here, for example, by a translationally driven guide carriage 3.

The drive train 2 comprises a drive, here designed as a (rotary) motor 4, and a drive element, here designed as a pinion 6, driven by the motor 4 by means of an optional gear 5. The motor 4, the gear 5 and the pinion 6 are attached to the guide carriage 3 and are thus moved with the guide carriage 3. The drive train 2 further comprises a fixed support element, shown here as a rack 7, with which the pinion 6 meshes in order to move the guide carriage 3 together with the motor 4, the gear 5 and the pinion 6 relative to the rack 7 in the longitudinal direction A thereof. The rotation of the motor 4, the gear 5 and the pinion 6, here counterclockwise, is indicated by arrows 19, 20 and 21.

As shown in FIGS. 2a and 2b, for functional reasons, the tooth thickness of the pinion 6 is smaller than the gap width between two teeth of the rack 7 by the (reverse) play S. If the pinion 6 is driven counterclockwise as shown in FIG. 2a, the pinion 6 rolls on the rack 7 and moves to the left (rotational movement 21, arrow direction A), shown here in particular with acceleration b1 of the pinion 6 to the left, causing the guide carriage 3 to move to the left together with the motor 4 and the gear 5. The pinion 6 engages with a tooth 8 in a tooth gap 9 of the rack 7, wherein the right tooth flank 8a of the tooth 8 is supported on the right tooth flank 9a of the tooth gap 9. If there is an acceleration reversal on the guide carriage 3 and thus also on the pinion 6, the right tooth flanks 8a, 9a separate from each other until, after completing the reverse play S, the left tooth flank 8b of tooth 8 now rests against the left tooth flank 9b of the tooth gap 9, as shown in FIG. 2b. The pinion 6 continues to move to the left (rotational movement 21, arrow direction A), rolling on the rack 7, but with acceleration b2 to the right, causing the guide carriage 3 to accelerate to the right together with the motor 4 and the gear 5.

The speed of the motor 4 is detected by means of a first device, here in the form of a motor measuring system 10. The ACTUAL acceleration of the motor 4 can then be determined from the detected speed. Alternatively, the ACTUAL acceleration of the motor 4 can also be determined using an additional acceleration sensor, which is attached to the pinion 6, for example.

The ACTUAL acceleration of the guide carriage 3 is determined by means of an acceleration sensor 11, which is attached to the guide carriage 3 itself or to one of the elements 4-6 that move with the guide carriage 3, for example here on the housing of the gear 5.

The value of the reverse play S of the drive train 2 can be determined in an evaluation device 12 from the detected ACTUAL accelerations of the drive 4 and the guide carriage 3.

The following method steps are carried out for automatically determining the value of the reverse play S.

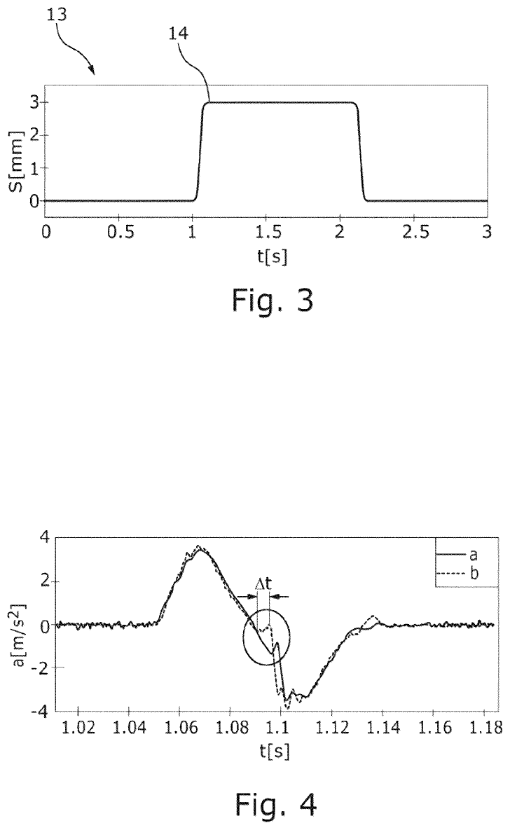

The guide carriage 3 is accelerated by the motor 4 by specifying a driving profile with acceleration reversal. The driving profile is stored in a motor control unit, for example. FIG. 3 shows such a driving profile 13 in a distance/time diagram in the form of a jerk-limited, step-shaped target trajectory 14 of the guide carriage 3. In the driving profile 13 shown, the guide carriage 3 moves forward by 3 mm in a step at time t=approx. 1 s and then moves back by 3 mm in a step at time t=approx. 2.2 s.

During this movement of the guide carriage 3, the ACTUAL acceleration of the motor 4 is detected by the motor measuring system 10 and the ACTUAL acceleration of the guide carriage 3 is detected by the acceleration sensor 11. More precisely, the engine acceleration can be ascertained from the detected motor speed by differentiation and optional smoothing.

In the evaluation device 12, the ACTUAL accelerations of the motor 4 and the guide carriage 3, which are detected synchronously or subsequently synchronized, are evaluated using various methods in order to determine the value of the reverse play S of the drive train 2.

FIG. 4 shows the accelerations of the motor 4 (solid line a) and the guide carriage 3 (dashed line b) detected for the driving profile 13 at time t=approx. 1 s in an acceleration (a)/time (t) diagram. During the transition from acceleration to deceleration, i.e., during acceleration reversal (zero crossing) at time t=approx. 1.1 s, a time offset Δt occurs between the two curves a and b, which results from the reverse play S. From this time offset Δt, the reverse play S can be determined by various methods.

In a first evaluation variable, the relationship between the changes in the acceleration processes of the ACTUAL accelerations of the motor 4 and the guide carriage 3 is experimentally ascertained and stored for different values of the reverse play S. When the tooth flanks collide after the acceleration reversal, the moving guide carriage 3 is abruptly braked or the motor 4 is jolted. The larger the reverse play S, the stronger these sudden changes in the acceleration processes are. This relationship can be experimentally ascertained and stored in the evaluation device 12. Based on the stored relationship, the value of the reverse play S can be determined from the detected ACTUAL accelerations of the motor 4 and the guide carriage 3.

In a second evaluation variable, the relationship between the period of time within which the pinion 6 and rack 7 separate from each other and come into contact with each other again during an acceleration reversal is experimentally ascertained and stored for different values of the reverse play S. The larger the reverse play S, the longer the period between the separation and the re-collision of the tooth flanks of the pinion 6 and rack 7. The moment of separation is when the motor 4 undergoes an acceleration reversal, e.g., when transitioning from acceleration to braking. The moment of collision is when the mass acceleration decreases abruptly or the motor acceleration increases abruptly. This relationship between this period and the reverse play S can be experimentally ascertained and stored in the evaluation device 12. Based on the stored relationship, the value of the reverse play S can be determined from the detected ACTUAL accelerations of the motor 4 and the guide carriage 3.

In a third evaluation variable, from the detected ACTUAL accelerations of the motor 4 and the guide carriage 3, the points in time at which, during an acceleration reversal, the pinion 6 and rack 7 separate from each other and come into contact with each other again, the distance traveled and, from this, the value of the reverse play S are calculated analytically. If the acceleration measurement signals are of sufficiently good quality (resolution, noise), the distance traveled and thus the reverse play S can be calculated analytically from the time of tooth flank separation and the time of tooth flank collision.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for automatically determining the value of a state variable of a drive train for moving a load, wherein the drive train comprises a drive and a drive element which is driven by the drive and moved with the load, and a fixed support element on which the drive element is supported, in order to move the load relative to the support element, comprising the following method steps:
a) accelerating the load by the drive by specifying a driving profile with acceleration reversal;
b) during the acceleration of the load, detecting an ACTUAL acceleration of the drive and detecting an ACTUAL acceleration of the load; and
c) determining the value of the state variable of the drive train by evaluating the detected ACTUAL accelerations of the drive and the load.

2. The method according to claim 1, wherein the state variable is a reverse play of the drive train.

3. The method according to claim 1, wherein the drive element meshes with the fixed support element in order to move the load relative to the fixed support element.

4. The method according to claim 1, wherein the drive is also moved with the load.

5. The method according to claim 1, wherein a speed of the drive designed as a rotary motor is detected and the ACTUAL acceleration of the drive is determined from the detected speed.

6. The method according to claim 5, wherein the speed of the rotary motor is detected by a motor measuring system of the rotary motor.

7. The method according to claim 1, wherein the ACTUAL acceleration of the load is detected by an acceleration sensor, which is mounted on the load itself or on an element moving with the load.

8. The method according to claim 1, wherein the ACTUAL accelerations of the drive and the load are detected synchronously during the acceleration of the load or are subsequently synchronized with each other after the detection processes.

9. The method according to claim 1, wherein a predetermined driving profile comprises a forward and backward movement of the load, exclusively a forward movement of the load, or exclusively a backward movement of the load.

10. The method according to claim 1, wherein a relationship between the state variable and the changes in the acceleration processes of the ACTUAL accelerations of the drive and the load is experimentally ascertained and stored for different values of the state variable, and that the value of the state variable is determined from the detected ACTUAL accelerations of the drive and the load using the stored relationship.

11. The method according to claim 1, wherein a relationship between the state variable and a period of time within which the drive and support elements separate from each other and come into contact with each other again during an acceleration reversal is experimentally ascertained and stored for different values of the state variable and that the value of the state variable is determined from the detected ACTUAL accelerations of the drive and the load using the stored relationship.

12. The method according to claim 1, wherein, from the detected ACTUAL accelerations of the drive and the load, points in time at which, during an acceleration reversal, the drive and support elements separate from each other and come into contact with each other again, the distance traveled and, from this, the value of the state variable are calculated analytically.

13. A device for automatically determining a value of a state variable of a drive train for moving a load, comprising:
the drive train comprising a drive and a drive element which is driven by the drive and moved with the load, and a fixed support element on which the drive element is supported, in order to move the load relative to the support element,
a first device for detecting an ACTUAL acceleration of the drive,
a second device for detecting an ACTUAL acceleration of the load, and
an evaluation device which is programmed to determine the value of the state variable of the drive train from the detected ACTUAL accelerations of the drive and the load.

14. The device according to claim 13, wherein the drive element meshes with the fixed support element.

15. The device according to claim 13, wherein the drive is also moved with the load.

16. The device according to claim 13, wherein the drive is an electric rotary or linear motor or a hydraulic motor.

17. The device according to claim 13, wherein the drive is an electric rotary motor and the first device is formed by a motor measuring system of the rotary motor for determining the motor speed.

18. The device according to claim 13, wherein the drive train has a gear acting between the drive and the drive element which is moved with the load.

19. The device according to claim 13, wherein the second device is formed by an acceleration sensor which is attached to the load itself or to an element which moves with the load.

20. The device according to claim 13, wherein the drive train is formed by a pinion/rack drive train or by a screw drive.
